(19) United States
(12) Patent Application Publication
(10) Pub. No.: US 2026/0235112 A1
(43) Pub. Date: Aug. 13, 2026

(54) BEARING UNIT AND WIND TURBINE HAVING A BEARING UNIT

(71) Applicants: thyssenkrupp rothe erde Germany GmbH, Dortmund (DE); thyssenkrupp AG, Essen (DE)

(72) Inventors: Daniel BECKER, Habichtswald-Ehlen (DE); Martin NEIDNICHT, Lippstadt (DE); Marco BURTCHEN, Lippstadt (DE); Alf TREDE, Immensted (DE)

(73) Assignees: thyssenkrupp rothe erde Germany GmbH, Dortmund (DE); thyssenkrupp AG, Essen (DE)

(21) Appl. No.: 19/154,692

(22) PCT Filed: Feb. 13, 2024
(86) PCT No.: PCT/EP2024/053604

§ 371 Date: Aug. 7, 2025

(30) Foreign Application Priority Data
Feb. 13, 2023 (DE) 10 2023 103 435.9
Feb. 13, 2023 (LU) LU103069

(51) Int. Cl. F03D 80/70; F16C 23/06; F16C 23/10; F16C 33/58

(52) U.S. Cl. CPC F03D 80/701; F16C 23/06; F16C 23/10; F16C 33/583; F05B 2240/50; F16C 2360/31

(57) ABSTRACT

A bearing unit for fastening a rotor blade to a hub of a wind turbine comprises a first bearing ring for fastening to the hub, a second bearing ring for fastening to the rotor blade, at least one series of rolling elements, and a pitch drive for angularly adjusting the two bearing rings relative to one another, wherein the first bearing ring is formed in one piece with a rotor hub extension which extends on the hub side in an axial direction beyond the second bearing ring, wherein the pitch drive comprises at least one electric pitch motor and a shaft, driven by the pitch motor, with a drive pinion which meshes with a toothing formed on the inside of the first bearing ring, wherein the pitch motor is arranged on the blade side on a reinforcement plate mounted on the second bearing ring and the shaft extends through an eccentrically arranged cutout in the reinforcement plate.

### PRIOR ART

The invention relates to a bearing unit for fastening a rotor blade to and angularly adjusting it on a hub of a wind turbine according to the preamble of claim 1, and to a wind turbine according to the preamble of claim 13.

The rotor blades of wind turbines are fastened to the hub by means of slewing bearings. Slewing bearings make it possible to adjust the pitch angle of the rotor blades with respect to the wind, this being necessary, among other things, in order to regulate the output of the wind turbine. In addition to the bearing, a drive is necessary for adjustment, this being mounted, in a conventional design, on the hub side, i.e. in a fixed manner, and causing the adjustment of the blade, for example, via a hydraulic cylinder that acts on the rotating part of the blade bearing unit.

Conventionally, the hub has been able to be transported to the construction site of the wind turbine in a preassembled manner with the slewing bearings and the blade pitch drives fastened thereto. On account of the continuously increasing rated output and the associated increase in size of the wind turbines, preassembled hubs that fit the desired blade root diameters have, in the meantime, frequently become no longer able to be transported by road. In order to overcome this obstacle, so-called extender solutions have been developed, in which the hub is intended to be kept as compact as possible. So-called hub extenders are then mounted at the connection faces of the hub, said hub extenders then in turn carrying the slewing bearings to which the rotor blades are fastened. In this way, the transport restrictions can be bypassed in that several more compact components are conveyed to the construction site and assembled there.

In order, furthermore, to increase the rigidity of the construction and, at the same time, to structurally adapt hub- and blade-side screw-connection diameters in a targeted manner with regard to the compactness of the hub and the increase in size of the blade root diameter to be used, DE 10 2018 211 430 A1 discloses the integration of the extender and slewing bearing, wherein the hub-side bearing ring of the slewing bearing is formed in one piece with a rotor hub extension. In addition, provision may be made for a pitch drive to be formed as part of the rotor hub extension or to be arranged within the rotor hub extension.

Usually, the pitch drive is still in the form of a hydraulic adjustment cylinder which is mounted on the hub side together with the fixed part of the slewing bearing. This is advantageous in particular with regard to the supply thereof with hydraulic medium, which is stored centrally in the hub for all blade pitch drives because it is then not necessary for hydraulic medium to be transferred into the rotating blade.

In addition to hydraulic drives, electric drives are also known in principle for rotor blade adjustment, for example from US 2008/0191488 A1. The described pitch drive is likewise mounted on the hub side on the fixed part and engages in a toothing on the blade-side inner ring of the blade bearing.

The use of such an electric drive in an integrated hub extender with a blade bearing is ruled out, however, because not only does an electric drive mounted on a hub-side reinforcement plate have to bridge the axial extent of the extender as far as the tooth engagement at the blade-side component of the bearing, but also, on the blade side—on account of the radial extent of the extender—with a corresponding radial offset with respect to the blade-side bearing ring, a sufficiently stable toothing with an appropriate toothing diameter has to be provided. This would be possible only with high design outlay and results in a correspondingly expensive technical solution with a high weight.

### DISCLOSURE OF THE INVENTION

Therefore, the invention addresses the problem of creating a bearing unit for fastening a rotor blade to and angularly adjusting it on the hub of a wind turbine, and of creating a wind turbine, which, in spite of the use of a rotor hub extension, allows cost-effective and simple structural attachment of the blade pitch drive, thereby simplifying the assembly of the bearing unit and also assembly in the field, and improving the accessibility of the drive components of the blade adjustment for maintenance work.

This problem is solved by a bearing unit having the features of claim 1 and by a wind turbine having the features of claim 13.

As a result, a bearing unit for fastening a rotor blade to and angularly adjusting it on a hub of a wind turbine is created, comprising a first bearing ring having first fastening bores for fastening to the hub and a second bearing ring having second fastening bores for fastening to the rotor blade. The second bearing ring is arranged coaxially with the first bearing ring and so as to be rotatable about the common axis with respect to the first bearing ring. The bearing unit furthermore comprises at least one series of rolling elements that are able to roll between the bearing rings in a raceway system, and a pitch drive which is designed to angularly adjust the two bearing rings relative to one another. The first bearing ring is formed in one piece with a rotor hub extension which extends on the hub side in an axial direction beyond the second bearing ring and in the hub-side end region of which the first fastening bores are arranged. The invention provides that the pitch drive comprises at least one electric pitch motor, a shaft which is driven by the pitch motor, and a drive pinion which is arranged on the shaft. The drive pinion meshes with a toothing formed on the inside of the first bearing ring. The pitch motor is arranged on the blade side on a reinforcement plate mounted on the second bearing ring and the shaft extends through an eccentrically arranged cutout in the reinforcement plate.

As a result of the blade-side fastening of the pitch motor to a reinforcement plate of the rotatable bearing ring of the bearing unit, the space available in the rotor blade is used in order to receive the pitch motor. The use of an electric pitch motor as a corotating drive simplifies the structural design and the assembly and mounting of the bearing unit in the wind turbine in the field. The power supply of the motor on the rotating ring can take place from the hub via a simple slip ring. Therefore, in contrast to a hydraulic supply, no pressure-tight rotary feedthroughs are required. The claimed integration of the pitch drive in the bearing unit reduces the assembly work to be carried out on site to a hub- and blade-side screw connection of the bearing unit, and the establishment of an electrical power supply. The space available in the hub remains free, in the connection region of the blade bearing unit, for assembly and maintenance work or the attachment of an additional reinforcement element to the hub. The bearing unit according to the invention can thus—independently of the hub—be delivered to the construction site in a fully prefabricated, assembled and tested (“ready-to-run”) state and be assembled easily.

In some embodiments, the pitch drive comprises a transmission which is interposed between the pitch motor and the shaft. The transmission adapts the rotational speed of the motor to the desired adjustment speed of the rotor blade.

Preferably, a control unit for controlling the pitch motor can also be arranged on the reinforcement plate, preferably on the side facing the hub. As a result of the arrangement of the control unit on the reinforcement plate, further space remains available in the hub interior. When use is made of a plurality of bearing units on a hub of a wind turbine, a single control unit arranged on the reinforcement plate can be provided for controlling the pitch motors of all the bearing units.

Preferably, a battery unit for emergency operation of the pitch motor can be arranged on the reinforcement plate, preferably on the side facing the hub. The battery unit can ensure an autonomous supply of the pitch motor with electric power for a limited time. In particular, the battery unit can have a capacity that allows at least emergency stop of the wind turbine by moving the rotor blade into the feathering position.

In some embodiments, the first bearing ring forms the outer ring of the bearing unit, and the toothing is formed in the hub-side end region of the rotor hub extension. These embodiments have the advantage that the adjustment forces introduced via the toothing are introduced into the bearing unit by the rotor hub extension at a distance from the raceway system of the bearing unit. Ring deformations, as can occur as a result of the introduction of high actuating and holding forces at the toothing, are thus transmitted to the raceway system only in an attenuated form. The functioning of the raceway system of the bearing unit is not impaired, let alone damaged, as a result, even in the event of high forces. In particular, it is preferred when the toothing is spaced apart from the raceway system along the extent of the rotor hub extension with a spacing which corresponds to at least half the axial extent of the second bearing ring.

In the embodiments in which the first bearing ring forms the outer ring of the bearing unit, it is preferred when the reinforcement plate is screwed together with the second bearing ring on the hub side. In this way, the axial spacing between the fastening of the pitch motor to the reinforcement plate and the tooth engagement of the drive pinion in the toothing is reduced. As a result, the rigidity of the pitch drive is increased.

Furthermore, a second reinforcement plate can optionally be screwed together with the second bearing ring on the blade side, the second reinforcement plate having a cutout for the passage of the pitch motor. The second reinforcement plate creates further reinforcement of the blade connection face and thus helps to make the forces introduced into the raceway system more uniform. The cutout in the second reinforcement plate furthermore allows the use of the space in the blade root for receiving the pitch motor.

In other embodiments, the first bearing ring forms the inner ring of the bearing unit, and the toothing is formed on the inside in the region of the raceway system. These embodiments have the advantage that the rotor hub extension does not have to bridge the entire radial distance between the connection face of the rotor hub and the connection face of the rotor blade, but the radial width of the raceway system of the bearing unit also helps to bridge this distance. With a given diameter ratio of blade root to hub connection face, these embodiments have a shorter radial lever arm of the rotor hub extension. Preferably, in these embodiments, the reinforcement plate is screwed together with the second bearing ring on the blade side.

Preferably, the rotor hub extension has a generally conical shape, the diameter of which decreases continuously from the raceway system to the hub-side end region. In particular, it is preferred when the rotor hub extension has, on its hub-side fastening face, an outside diameter which is less than an inside diameter of the first bearing ring in the region of the raceway system. In this way, the technical advantage is achieved of it being possible to fasten rotor blades that are as large as possible to a hub that is as small as possible. The larger diameter of the raceway system compared with the outside diameter of the rotor hub extension on the hub-side fastening face also increases the load-bearing capacity of the blade mounting, this having a beneficial effect on durability and service life.

The problem is also solved by a wind turbine comprising a tower, a nacelle, and a rotor mounted rotatably on the nacelle. The rotor comprises a hub and a plurality of rotor blades mounted rotatably on the hub, wherein at least one of the rotor blades is mounted on the hub by means of the above-described bearing unit.

Preferably, the hub has an annular reinforcement means in a connection region for the bearing unit. The use of an annular reinforcement means in the connection region of the hub ensures that the drive components of the bearing unit remain accessible. The annular reinforcement means may be, for example, a cast-on reinforcement ring or a reinforcement plate with a sufficiently large central cutout, which allows access to the components of the pitch drive.

Further advantageous embodiments can be found in the following description and the dependent claims.

The invention is explained in more detail in the following text by way of the exemplary embodiments illustrated in the appended drawings.

### BRIEF DESCRIPTION OF THE DRAWINGS

FIG. 1 schematically shows a wind turbine according to the invention, the rotor blades of which are mounted on the hub by means of bearing units according to the invention,

FIG. 2 schematically shows a perspective illustration, in partial section, of a rotor hub having two bearing units according to the invention according to a first exemplary embodiment of the invention,

FIGS. 3 and 4 schematically show perspective detail illustrations, in partial section, of the bearing unit according to FIG. 2, and

FIG. 5 schematically shows a second exemplary embodiment of the bearing unit according to the invention, in which the first bearing ring forms the inner ring of the bearing unit.

### EMBODIMENTS OF THE INVENTION

In the various figures, identical parts are always provided with the same reference signs and are therefore each generally cited or mentioned only once.

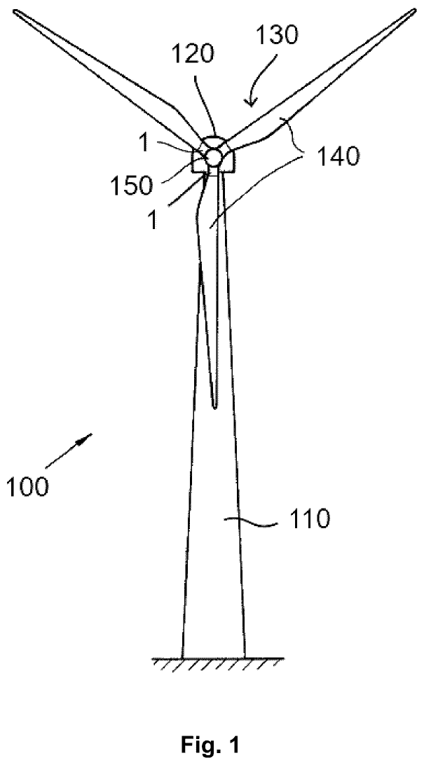

FIG. 1 shows a wind turbine 100 according to the invention. The wind turbine 100 comprises a tower 110, a nacelle 120, and a rotor 130 mounted rotatably on the nacelle 120. The rotor 130 comprises a hub 150 and a plurality of rotor blades 140 mounted rotatably on the hub 150. Usually, the rotor 130 comprises three rotor blades 140, as illustrated. The rotor blades 140 are mounted rotatably on the hub in order to allow regulation of the output of the wind turbine 100 under varying wind conditions. Furthermore, it is possible to adjust the rotor blades 140 into the feathering position, i.e. in the wind direction, in order to minimize the power consumption of the rotor blades 140 and to take the wind turbine 100 out of operation.

At least one of the rotor blades 140 is mounted on the hub 150 by means of a bearing unit 1 according to the invention. Preferably, all the rotor blades 140 are mounted on the hub 150 by means of bearing units 1 according to the invention.

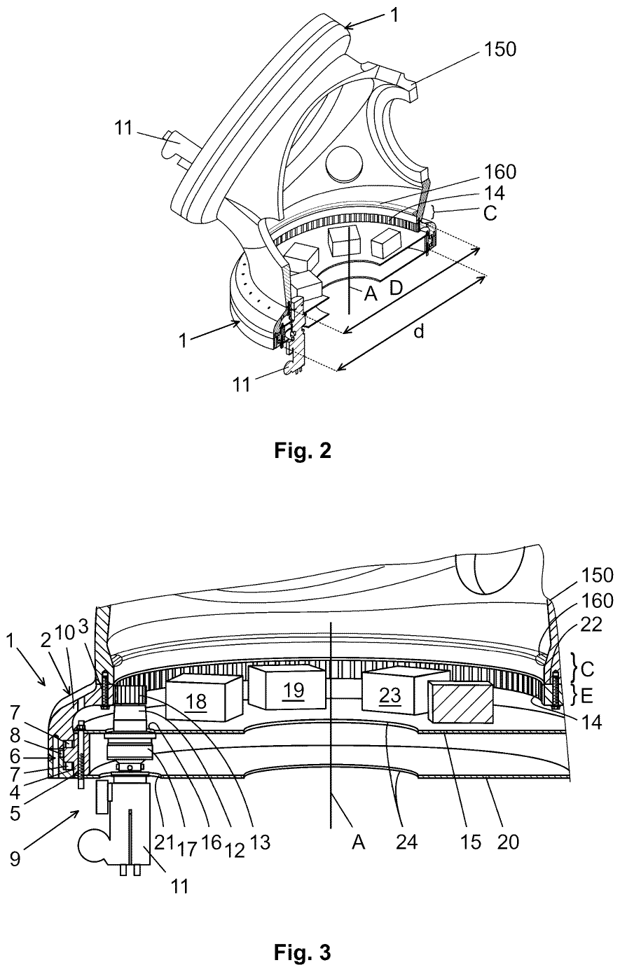

The bearing units 1 according to the invention and the fastening thereof to the hub 150 are explained in more detail in the following text with reference to FIGS. 2 to 5.

FIG. 2 to FIG. 4 illustrate a first exemplary embodiment of a bearing unit 1 according to the invention, which is fastened to the hub 150 of a wind turbine. FIG. 2 shows a perspective illustration, in partial section, of a hub 150 with two bearing units 1 fastened thereto. In a first connection region C for the bearing unit 1, the hub 150 has an annular reinforcement means 160. The annular reinforcement means 160 is in this case in the form of a cast-on reinforcement ring. Such an annular reinforcement means 160 allows access to the components of the bearing unit 1 from the interior of the hub 150 and in this simplifies assembly and maintenance work.

The first exemplary embodiment, illustrated in FIGS. 2 to 4, of the bearing unit 1 according to the invention for fastening a rotor blade to and angularly adjusting it on a hub 150 of a wind turbine comprises a first bearing ring 2 having first fastening bores 3 for fastening to the hub 150 and a second bearing ring 4 having second fastening bores 5 for fastening to the rotor blade 140 (cf. FIG. 1). The second bearing ring 4 is arranged coaxially with the first bearing ring 2 and so as to be rotatable about the common axis A with respect to the first bearing ring 2.

The first bearing ring 2 is formed in one piece with a rotor hub extension 10. The rotor hub extension 10 extends on the hub side in an axial direction A beyond the second bearing ring 4. The first fastening bores 3 are arranged in the hub-side end region E of the rotor hub extension 10.

Preferably, the rotor hub extension 10 is conical and its diameter widens from the hub-side end region E to the blade-side fastening face. It is particularly preferred when the rotor hub extension 10 has, on its hub-side fastening face 22, an outside diameter D that is less than an inside diameter d of the first bearing ring 2 in the region of the raceway system 6 (cf. FIG. 2).

The bearing unit 1 also comprises at least one series of rolling elements 7, 8 that are able to roll between the bearing rings (2, 4) in a raceway system 6. According to the exemplary embodiment illustrated, three series of rolling elements are provided, in particular two series of axial rollers 7 and one series of radial rollers 8. The rolling elements may be, for example, cylindrical rollers, tapered rollers or balls. In order to simplify the assembly of the raceway system 6 with the series of rolling elements, provision may be made, depending on the bearing design, for the first bearing ring 2 and/or the second bearing ring 4 to be formed at least in two parts, for example with a support ring 2′; 4′ and a retaining ring 2″; 4″. Even though the invention is applicable in principle with all conceivable kinds of rolling elements 7, 8 and raceway systems 6, it is preferred when the bearing rings 2, 4 form, with the raceway system 6 and the rolling elements 7, 8, a three-series roller-bearing slewing ring (as illustrated in the figures) or a two-series four-point ball bearing (not illustrated). Combinations of roller raceways and ball raceways are likewise possible, if appropriate.

Finally, the bearing unit 1 comprises a pitch drive 9 which is designed to angularly adjust the two bearing rings 2, 4 relative to one another. The pitch drive 9 comprises at least one electric pitch motor 11, a shaft 12 which is driven by the pitch motor 11, and a drive pinion 13 which is arranged on the shaft 12. The drive pinion 13 meshes with a toothing 14 formed on the inside of the first bearing ring 2. The toothing 14 is provided preferably around the entire circumference of the bearing unit 1. However, a toothing 14 that is formed only in segments on the inner circumference of the bearing unit 1 is also conceivable, wherein the center angle of the toothing segment(s) then corresponds to the maximum adjustment angle of the pitch drive 9. The toothing segments may have, for example, a center angle of between 30° and 360°.

The electric pitch motor 11 is arranged on the blade side on a reinforcement plate 15 mounted on the second bearing ring 4, said reinforcement plate having an eccentric cutout 16 through which the shaft 12 extends. For fastening the electric pitch motor 11, fastening means are provided on the reinforcement plate 15, for example a flange or a hole circle (not illustrated). Preferably, the pitch motor 11 extends in the axial direction A on the blade side beyond the second bearing ring 4 and thus uses the space available in the rotor blade 140. The pitch motor 11 accordingly extends in the axial direction A preferably entirely in the region of the bearing unit 1 and optionally of the rotor blade 140.

Depending on the design of the wind turbine 100, the bearing unit 1 can also be equipped with a plurality of electric pitch motors 11 of identical design that are arranged in a manner distributed around the circumference of the toothing 14. This may be advantageous in particular for wind turbines 100 in the multi-megawatt range, in order to distribute the acting forces better over the toothing circle.

Preferably, the pitch drive 9 comprises a transmission 17, which is interposed between the pitch motor 11 and the shaft 12 in order to convert the motor speed to a preferred adjustment speed of the rotor blade 140. The pitch motor 11 can be fastened to the reinforcement plate 15 by means of the transmission 17.

As is likewise apparent from the first exemplary embodiment, it is an advantage of the invention that the reinforcement plate 15, which serves to fasten the pitch motor 11, can also be used for the space-optimized arrangement of the motor control. Thus, provision is preferably made for a control unit 18 for controlling the electric pitch motor 11 to be arranged on the hub side on the reinforcement plate 15. Likewise, a battery unit 19 for emergency operation of the pitch motor 11 can preferably be arranged on the hub side on the reinforcement plate 15. In addition or as part of the control unit 18, a converter 23 can be arranged on the hub side on the reinforcement plate 15. Preferably, the control unit 18 and/or the battery unit 19 and/or the converter 23 extend in the axial direction A entirely within the bearing unit 1. The interior of the hub 150 can thus preferably remain entirely free of components for controlling the pitch drive 9 and these abovementioned components of the pitch drive in the rotor hub extension can be mounted independently of the hub.

According to the first exemplary embodiment, the first bearing ring 2 forms the outer ring of the bearing unit 1 and the toothing 14 is formed in the hub-side end region E of the rotor hub extension 10. In order to achieve a rigidity of the pitch drive 9 that is as high as possible, it is preferred for the reinforcement plate 15 to be screwed together with the second bearing ring 4 on the hub side. As a result, the axial spacing between the fastening of the pitch motor 11 to the reinforcement plate 15 and the tooth engagement of the drive pinion 13 is reduced.

In addition, a second reinforcement plate 20 can be screwed together with the second bearing ring 4 on the blade side, said second reinforcement plate having a cutout 21 for the passage of the pitch motor 11. The two reinforcement plates 15, 20 form, together with the second bearing ring 4, in a sandwich-like construction, a particularly torsion-resistant construction for fastening the rotor blade 140 with a comparatively low weight, this having a beneficial effect for the introduction of load into the blade.

The first reinforcement plate 15 and—if present—also the second reinforcement plate 20 preferably have an opening 24 for maintenance work. The opening 24 is preferably dimensioned such that a technician can climb into the blade interior through the opening. Preferably, the opening 24 is arranged centrally in the reinforcement plate 15, 20.

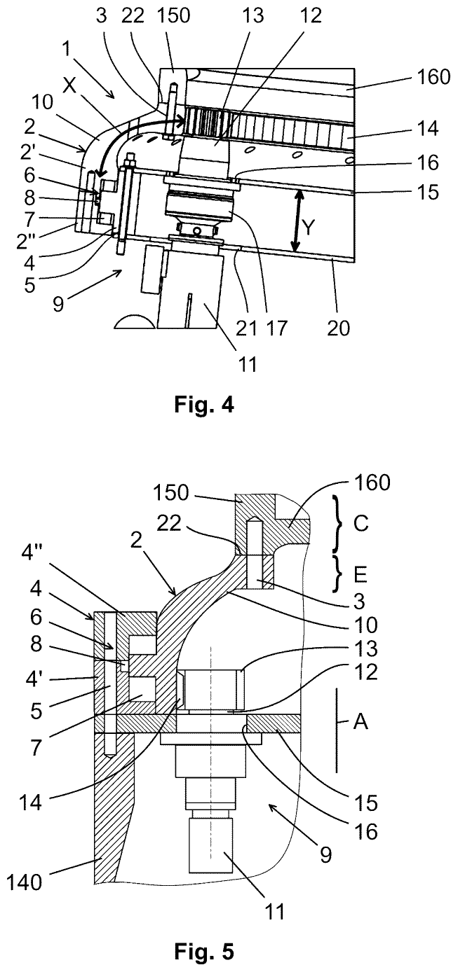

As is apparent in particular from FIG. 4, the toothing 14 can be spaced apart from the raceway system 6 along the extent of the rotor hub extension 10 with a spacing X which corresponds to at least half the axial extent Y of the second bearing ring 4. This sufficiently large spacing of the toothing 14 protects the raceway system 6 reliably from the introduction of excessive adjustment forces which could damage the raceway system 6 and/or the rolling elements 7, 8. In the exemplary embodiment illustrated, the spacing X even exceeds the axial extent Y of the second bearing ring 4.

FIG. 5 shows a second exemplary embodiment of the bearing unit 1 according to the invention. In contrast to the first exemplary embodiment, the first bearing ring 2 forms the inner ring of the bearing unit 1 and the toothing 14 is formed on the inside in the region of the raceway system 6. Furthermore, the reinforcement plate 15 has been screwed together with the second bearing ring 4 on the blade side.

Otherwise, the information provided in relation to the first exemplary embodiment according to FIGS. 2 to 4 also applies to the second exemplary embodiment, mutatis mutandis.

According to an exemplary embodiment that is not illustrated, further functionalities can also be incorporated in the bearing unit via attachment parts. For example, the bearing unit may comprise a lubricating grease pump for lubricating the raceway systems of the bearing unit. Alternatively or additionally, a locking device for locking the pitch drive or the angular adjustment (a so-called pitch lock) may also be incorporated in the bearing unit. These attachment parts may likewise be mounted on one of the two reinforcement plates.

Otherwise, the information provided in relation to the exemplary embodiments according to FIGS. 2 to 5 also applies, mutatis mutandis.

### LIST OF REFERENCE SIGNS

1 Bearing unit
2 First bearing ring
2′ Support ring
2″ Retaining ring
3 First fastening bores
4 Second bearing ring
4′ Support ring
4″ Retaining ring
5 Second fastening bores
6 Raceway system
7, 8 Series of rolling elements
9 Pitch drive
10 Rotor hub extension
11 Electric pitch motor
12 Shaft
13 Drive pinion
14 Toothing
15 Reinforcement plate
16 Cutout
17 Transmission
18 Control unit
19 Battery unit
20 Second reinforcement plate
21 Cutout in second reinforcement plate
22 Hub-side fastening face of the rotor hub extension
23 Converter
24 Opening
100 Wind turbine
110 Tower
120 Nacelle
130 Rotor
140 Rotor blade
150 Hub
160 Annular reinforcement means
A Axis of the bearing unit
C Connection region of the hub
d Inside diameter of the first bearing ring in the region of the raceway system
D Outside diameter of the first bearing ring at the hub-side fastening face
E Hub-side end region of the rotor hub extension
X Spacing
Y Axial extent of the second bearing ring

1-14. (canceled)

15. A bearing unit for fastening a rotor blade to and angularly adjusting it on a hub of a wind turbine, comprising:
a first bearing ring having first fastening bores for fastening to the hub;
a second bearing ring having second fastening bores for fastening to the rotor blade, wherein the second bearing ring is arranged coaxially with the first bearing ring and so as to be rotatable about the common axis with respect to the first bearing ring;
at least one series of rolling elements that are able to roll between the bearing rings in a raceway system; and
a pitch drive which is designed to angularly adjust the two bearing rings relative to one another;
wherein the first bearing ring is formed in one piece with a rotor hub extension which extends on the hub side in an axial direction beyond the second bearing ring and in the hub-side end region of which the first fastening bores are arranged;
wherein the pitch drive comprises at least one electric pitch motor, a shaft which is driven by the pitch motor, and a drive pinion which is arranged on the shaft and which meshes with a toothing formed on the inside of the first bearing ring, wherein the pitch motor is arranged on the blade side on a reinforcement plate mounted on the second bearing ring and the shaft extends through an eccentrically arranged cutout in the reinforcement plate.

16. The bearing unit as claimed in claim 15, wherein the pitch drive comprises a transmission which is interposed between the pitch motor and the shaft.

17. The bearing unit as claimed in claim 15, wherein a control unit for controlling the pitch motor is arranged on the reinforcement plate, preferably on the side facing the hub.

18. The bearing unit as claimed in claim 15, wherein a battery unit for emergency operation of the pitch motor is arranged on the reinforcement plate, preferably on the side facing the hub.

19. The bearing unit as claimed in claim 15, wherein the pitch motor extends in the axial direction beyond the second bearing ring on the blade side.

20. The bearing unit as claimed in claim 15, wherein the first bearing ring forms the outer ring of the bearing unit, and the toothing is formed in the hub-side end region of the rotor hub extension.

21. The bearing unit as claimed in claim 20, wherein the reinforcement plate is screwed together with the second bearing ring on the hub side.

22. The bearing unit as claimed in claim 21, wherein a second reinforcement plate is screwed together with the second bearing ring on the blade side, the second reinforcement plate having a cutout for the passage of the pitch motor.

23. The bearing unit as claimed in claim 20, wherein the toothing is spaced apart from the raceway system along the extent of the rotor hub extension with a spacing which corresponds to at least half the axial extent of the second bearing ring.

24. The bearing unit as claimed in claim 15, wherein the first bearing ring forms the inner ring of the bearing unit, and the toothing is formed on the inside in the region of the raceway system.

25. The bearing unit as claimed in claim 24, wherein the reinforcement plate is screwed together with the second bearing ring on the blade side.

26. The bearing unit as claimed in claim 15, wherein the rotor hub extension has, on its hub-side fastening face, an outside diameter which is less than an inside diameter of the first bearing ring in the region of the raceway system.

27. A wind turbine, comprising:
a tower;
a nacelle; and
a rotor mounted rotatably on the nacelle;
wherein the rotor comprises a hub and a plurality of rotor blades mounted rotatably on the hub;
wherein at least one of the rotor blades is mounted on the hub by a bearing unit as claimed in claim 15.

28. The wind turbine as claimed in claim 27, wherein the hub has annular reinforcement in a connection region for the bearing unit.
